(19) United States
(12) Patent Application Publication
(10) Pub. No.: US 2012/0023542 A1
(43) Pub. Date: Jan. 26, 2012

(54) VIDEO DISPLAY AND SET-TOP BOX FOR SCHEDULING

(75) Inventor: LUNG DAI, Tu-Cheng (TW)

(73) Assignee: HON HAI PRECISION INDUSTRY CO., LTD., Tu-Cheng (TW)

(21) Appl. No.: 13/151,348

(22) Filed: Jun. 2, 2011

(30) Foreign Application Priority Data
Jul. 22, 2010 (TW) 99124090

(51) Int. Cl. H04N 5/445; H04N 7/173

(52) U.S. Cl. 725/134; 348/563; 348/E05.099

(57) ABSTRACT

A video display includes a display, a memory, a timer, and a processor. The memory is used for storing schedules and a predetermined time intervals, wherein each schedule comprising at least one scheduled event and at least one predetermined time corresponding to the at least one scheduled event. The timer is used for obtaining a current time. The processor is used for obtaining a scheduled event based on the current time and the predetermined time interval, and displaying the obtained scheduled event in the display. A set-top box is also provided.

### BACKGROUND

1. Technical Field

The present disclosure relates to video displays and set-top boxes.

2. Description of Related Art

Everyday family life involves a myriad of mundane activities, for example, recurring soccer games, piano lessons, doctor's appointments, work schedules, and much more. These events must all be scheduled and coordinated. Paper calendars are one tool used to help stay organized. However, paper calendars cannot warn users of scheduled events.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout views.

FIG. 1 is a block diagram of a video display in accordance with an embodiment.

FIG. 2 is a schematic view showing a schedule stored in the video display of FIG. 1.

FIG. 3 is a block diagram of a set-top box in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

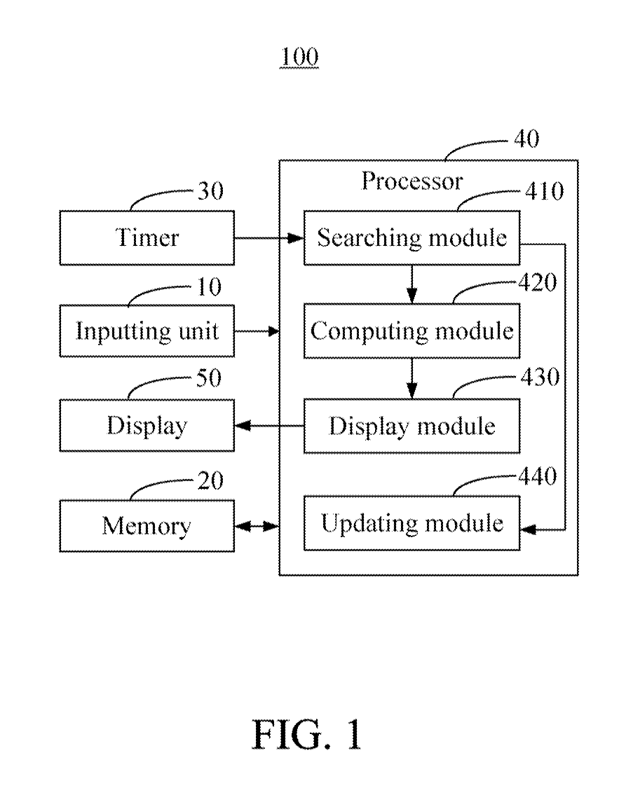

Referring to FIG. 1, a block diagram of a video display 100 in accordance with an embodiment is shown. The video display 100 is adaptive to display reminder to users to warn of scheduled events. In the embodiment, the video display 100 is a television. The video display 100 includes an input unit 10, a memory 20, a timer 30, a processor 40, and a display 50.

The input unit 10 is used to input and edit predetermined schedules in response to the operations of the user. Each predetermined schedule includes at least one scheduled event and at least one related predetermined time corresponding to the at least one scheduled event, for example, a predetermined schedule is soccer game at Mar. 2, 2011. The input unit 10 is a remote control in the embodiment.

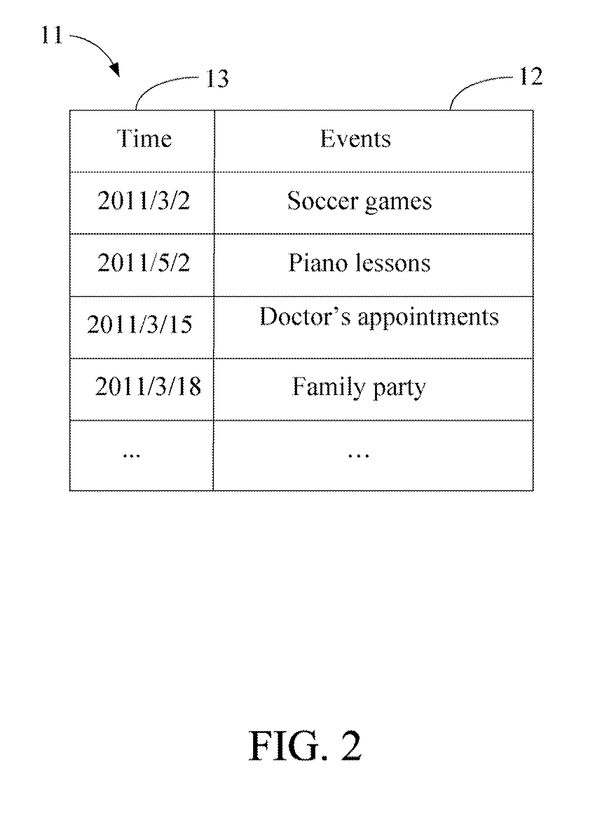

The memory 20 is used to store the predetermined schedules. Referring to FIG. 2, in the embodiment, the predetermined schedules are recorded in a calendar 11. The calendar 11 includes two columns 12 and 13 (hereinafter, a first column 12 and a second column 13). The first column 12 records scheduled events, and the second column 13 records related predetermined times corresponding to the scheduled events. The memory 20 further stores a predetermined time interval. The time interval may be zero minutes to several weeks in some embodiments.

The timer 30 is used to obtain a current time and transmit the obtained current time to the processor 40. The timer 30 may time the current time by itself.

The processor 40 is used to obtain a scheduled event from the calendar 11 based on the current time obtained by the timer 30 and the predetermined time interval, and to display the obtained scheduled event and the predetermined time corresponding to the obtained scheduled event in the display 50. In the embodiment, the processor 40 obtains a scheduled event of which the predetermined time is at the predetermined time interval from the current time, for example, if the current time obtained by the timer 30 is Apr. 27, 2011, and the predetermined time interval is 7 days, then the processor 40 searches the calendar 11 to obtain the scheduled event of which the related time is between Apr. 27, 2011 and May 4, 2011. If the predetermined time of a scheduled event “Piano lessons” is May 2, 2011, the scheduled event “Piano lessons” is to be obtained, and the processor 40 displays the scheduled event “Piano lessons at May 2, 2011” in the display 50 as a reminder. The processor 40 further is used to compute a time interval between the current time and the predetermined time corresponding to the obtained scheduled event, and displays the time interval as well as the obtained scheduled event. For example, when the processor 40 obtains the scheduled event “Piano lessons” based on the current time Apr. 27, 2011 and the predetermined time May 2, 2011. The processor 40 computes the time interval between the current time Apr. 27, 2011 and the predetermined time May 2, 2011 corresponding to the scheduled event “Piano lessons” and obtains the time interval is 5 days, thus, the processor 40 displays reminder “Piano lessons is in 5 days later”. Furthermore, the processor 40 is used to obtain and delete an expired scheduled event of which predetermined time is before the current time, thereby saving storage space of the memory 20. For example, in the calendar 11, the predetermined time corresponding to a scheduled event “soccer games” is Mar. 2, 2011 and the current time Apr. 27, 2011, thus, the scheduled event “soccer games” has expired and the processor 40 deletes the scheduled event “soccer games”.

Referring to FIG. 1 again, the processor 40 includes a searching module 410, a computing module 420, a display module 430, and an updating module 440. The searching module 410 is used to obtain a scheduled event recorded in the calendar 11 based on the current time obtained by the timer 30 and the predetermined time interval stored in the memory 30. The computing module 420 is used to compute a time interval between the current time and the predetermined time corresponding to the obtained scheduled event. The display module 430 is used to display the obtained scheduled event as reminder in the display 50. The searching module 410 is further used to search a scheduled event of which the predetermined time is expired. The updating module 440 is used to delete the scheduled event that has expired.

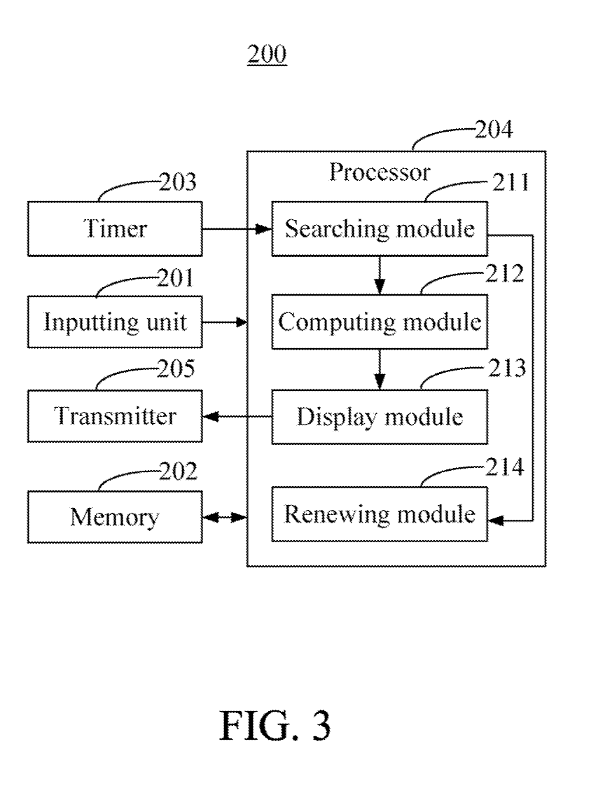

Referring to FIG. 3, a block diagram of a set-top box 200 in accordance with another embodiment is shown. The set-top box 200 is used to receive TV signals and transmit the TV signals to a video display, such as, a television (not shown). The set-top box 200 is also capable of displaying reminder to users to warn of scheduled events. The functions of the input unit 201, the memory 202, the timer 203, and the processor 204 of the set-top box 200 are similar to the functions of the input unit 10, the memory 20, the timer 30, and the processor 40 of the video display 100 respectively. The set-top box 200 further includes a transmitter 205. The transmitter 205 is used to transmit the received TV signals and the obtained scheduled events to the video display, such that the obtained scheduled event can be displayed in the video display as reminder.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A video display, comprising:
a display;
a memory for storing schedules and a predetermined time interval, each schedule comprising at least one scheduled event and at least one related predetermined time corresponding to the at least one scheduled event;
a timer for obtaining a current time, and
a processor for obtaining a scheduled event based on the current time and the predetermined time interval, and controlling the display to display the obtained scheduled event in the display.

2. The video display of claim 1, wherein the schedules are recorded in a calendar, and the calendar comprises a first column for recording the at least one scheduled event and a second column for recording the at least one predetermined time corresponding to the at least one scheduled event.

3. The video display of claim 1, wherein the processor comprises a searching module and a display module, the searching module is configured to obtain a scheduled event based on the current time and the predetermined time interval, and the display module is configured to display the obtained scheduled event in the display.

4. The video display of claim 3, wherein the searching module is configured to obtain a scheduled event of which the related predetermined time is at the predetermined time interval from the current time.

5. The video display of claim 4, wherein the searching module is used to obtain a scheduled event of which the related predetermined time is expired.

6. The video display of claim 5, wherein the processor further comprises an updating module configured to delete a scheduled event of which the related predetermined time is expired.

7. The video display of claim 3, wherein the processor further comprises a computing module configured to compute a time interval between the current time and the predetermined time corresponding to the obtained schedule.

8. The video display of claim 7, wherein the display module is further configured to display the time interval.

9. A set-top box applied to a video display, comprising:
a memory for storing schedules and a predetermined time interval, wherein each schedule comprising at least one scheduled event and at least one related predetermined time corresponding to the at least one scheduled event; and
a timer for obtaining a current time;
a processor for obtaining a scheduled event based on the current time and the predetermined time interval, and displaying the obtained scheduled event in the video display.

10. The set-top box of claim 9, wherein the schedules are recorded in a calendar, the calendar comprises a first column for recording the at least one scheduled event, and a second column for recording the at least one predetermined time corresponding the scheduled event.

11. The set-top box of claim 9, wherein the processor comprises a searching module and a display module, the searching module is configured to obtaining the scheduled event based on the current time and the predetermined time interval, and the display is configured to display the obtained scheduled event in the display.

12. The set-top box of claim 11, wherein the searching module is configured to obtain a scheduled event which related predetermined time is at the predetermined time interval from the current time.

13. The set-top box of claim 12, wherein the searching module is used to obtain the scheduled event which related predetermined time is expired.

14. The set-top box of claim 13, wherein the processor further comprises an updating module, the updating module is configured to delete the scheduled event which related predetermined time is expired.

15. The set-top box of claim 11, wherein the processor further comprises a computing module, the computing module is configured to compute a time interval between the current time and the predetermined time corresponding to the obtained scheduled.

16. The set-top box of claim 15, wherein the display module is further configured to display the time interval.

17. The set-top box of claim 9, further comprising a transmitter, the transmitter for transmitting the obtained scheduled event to the video display.
